(19) United States
(12) Patent Application Publication
(10) Pub. No.: US 2007/0005406 A1
(43) Pub. Date: Jan. 4, 2007

(54) Event scheduling

(76) Inventors: Behrad Assadian, Ipswich (GB); Behnam Azvine, Ipswich (GB); Simon James Case, Saxmundham (GB)

Correspondence Address: NIXON & VANDERHYE, PC, 901 NORTH GLEBE ROAD, 11TH FLOOR, ARLINGTON, VA, 22203, US

(21) Appl. No.: 10/550,792

(22) PCT Filed: Mar. 5, 2004
(86) PCT No.: PCT/GB04/00975

§ 371 Date: Sep. 22, 2005

(30) Foreign Application Priority Data
Mar. 31, 2003 (GB) 0307392.1
Aug. 15, 2003 (GB) 0319254.9

(51) Int. Cl. G05B 19/418

(52) U.S. Cl. 705/8

(57) ABSTRACT

An apparatus is provided for use in scheduling events on behalf of a plurality of participating physical entities. The apparatus comprises evaluating means and scheduling means, the evaluating means being arranged to evaluate a received event request containing information about the event and to generate an input to the scheduling means with respect to one or more physical entities identified in the received event request. The evaluating means is arranged, on behalf of physical entities identified in the received event request, to calculate a value for each of a plurality of predetermined measures, including a measure of the importance of the requested event to an identified entity, using an appropriate rule set for each measure, and using a further rule set, to combine the calculated values and so derive and output a value representative of the overall degree of support by the identified physical entity for the requested event, for input to the scheduling means. Preferably, the apparatus uses fuzzy processing techniques to calculate the various values, represented as fuzzy sets. The fuzzy sets, fuzzy rules and rule weightings are personalised to individual participants, or groups, to enable adjustment of the evaluating means based upon participant feedback.

This invention relates to scheduling of events on behalf of participating entities and in particular to a method for evaluating event proposals on behalf of such entities.

There are a number of known techniques for scheduling meetings and similar types of event. For example, it is known to apply various types of optimisation algorithm to the problem of finding a meeting slot that satisfies constraints on participant availability. More sophisticated techniques are able to consider meeting location and the identity of other invited participants, besides time-related parameters, when attempting to define a meeting acceptable to some degree to a group of meeting invitees. However, in view of the escalating difficulty in satisfying participant constraints as the number of potential participants increases, the types of event parameter generally considered in known scheduling techniques is necessarily restricted, for example to a consideration of meeting time, location and the identity of other invitees.

In order to “soften” the constraints to be taken into account when attempting to define the parameters of a meeting, it is known to take account of participant preferences relating to day, time and duration, for example, and to define such preferences as fuzzy sets. Fuzzy logic processing is then applied to combine a participant's preferences with respect to the parameters in a meeting proposal to determine the degree to which the participant's preferences are satisfied overall. The results of this analysis are then used to decide whether or not the meeting proposal is acceptable. This function may be performed by a software agent acting on behalf of a potential meeting participant.

However, binary-style responses are not particularly useful when the scheduler is attempting to find the best possible meeting, e.g. when attempting to set up a meeting with as many of the invited participants as possible (for, say, 100 invitees). For example, 90 people attending at 10:00 am on a Monday may be better than 91 people at 4:30 pm on a Friday, or 70 people attending with all the senior managers present may be better than 90 people with none.

According to a first aspect of the present invention, there is provided an event scheduling apparatus for use in scheduling events on behalf of a plurality of participating physical entities, the apparatus comprising evaluating means and scheduling means, the evaluating means being arranged to evaluate a received event request comprising information about the event and to generate an input to the scheduling means with respect to one or more physical entities identified in the received event request, the evaluating means comprising determining means operable on behalf of at least one physical entity identified in the received event request, to:

a) determine a value for each of a plurality of predetermined measures, said measures including a measure of the importance of the requested event to said at least one physical entity, the value for each said measure being derived according to a rule set for the measure by combining information about the event with data obtained from at least one information source associated with said at least one physical entity; and

b) combine said determined values, according to a further rule set, to derive a value indicative of the overall degree of support by said at least one physical entity for the requested event, and to output said derived value for input to the scheduling means,

wherein at least one of said values is defined by means of a fuzzy set, at least one of said rule sets comprise at least one fuzzy rule and wherein said determining means comprise at least one fuzzy logic processor.

In a preferred embodiment of the present invention, the determining means are implemented, in use, as a plurality of participant software agents, each participant software agent being operable on behalf of at least one physical entity identified in the received event request. Additionally, the evaluating means may further comprise a proposer software agent operable to receive an event request and, for one or more physical entities identified therein, to:

i) determine a value for a measure of the importance of the identified physical entity to the requested event, each said value being derived according to a rule set for said measure by combining information about the event with data obtained from at least one information source associated with the identified physical entity; and

ii) generate an event proposal comprising the importance value from i) together with information about the event, for sending to the respective participant software agent for the identified physical entity.

A successful meeting agent (a “participant” or “attendee” agent) needs to usefully combine information from a variety of sources to assign importance and preference values to proposed meetings and time slots. Prior art has included methods for assigning preferences based on time and acquaintances but these need to be specified by the user. They have not included importance factors with respect to i) each attendee and/or ii) the meeting to the user.

It is particularly advantageous to use fuzzy processing techniques to implement preferred embodiments of the present invention when attempting to schedule events that are likely to involve a number of physical entities for which there are multiple constraints or preferences to be taken into account. Certain constraints and preferences are inherently imprecise concepts, each contributing to a differing extent to an overall measure of whether a particular entity is “supportive” of a requested event. Hence the use of fuzzy rules to combine fuzzy representations of certain predetermined measures likely to influence an entity's participation in a given event makes for a more flexible and easily adjustable scheduling system.

Preferably, in the event scheduling apparatus, the evaluating means further comprise adjusting means arranged to receive feedback by, or on behalf of, a physical entity in relation to an output by the scheduling means corresponding to a received event request in which said physical entity is identified, and to make adjustments to fuzzy sets and/or rule weightings in accordance with said received feedback.

Self-adaptivity of a meeting agent has been shown to be highly advantageous in that it greatly reduces the quantity of user input required to fine-tune operation of the agent operating on the users behalf.

Preferred embodiments of the present invention provide: i) a method of augmenting a meeting proposal to assign importance values to potential attendees; ii) means of calculating the importance value of a meeting to a user; iii) combining exterior sources of information with diary information to reply to a meeting proposal in a nuanced manner using fuzzy rules; and iv) a method for adapting these fuzzy rules given feedback from the user.

An attendee (participant) agent according to preferred embodiments of the present invention is arranged to find appropriate preference information in respect of each meeting invitee and to combine that information to form an appropriate output which can be used by many known scheduling methods. The attendee agent uses exterior information to estimate factors relevant to a proposed meeting slot. In particular the agent decides on importance of the meeting to the user and importance of the user to the meeting on behalf of each invitee. A proposer agent uses fuzzy systems to combine exterior information to augment a meeting proposal. The attendee agent uses a learned overall busyness of each invitee from responses to previous proposals. It combines this information with the position of each invitee within a respective organisation or within an acquaintance list to assign a value corresponding to the importance of invitee to the meeting for each invitee.

The preferred attendee agent uses fuzzy systems to combine calendar, slot preference and importance information and to respond to a meeting proposal with a value in the range [0,1] (where 0 means “cannot attend” and 1 means “can attend, and this is the ideal time”). The attendee agent uses exterior information to estimate importance, busyness and availability values from exterior information (e.g. diary, user interest profile, organisation chart.)

An advantageous feature of preferred embodiments of the present invention is adaptability and tolerance for uncertainty. The processes described in the detailed description below use what is known as “soft computing” techniques. These techniques provide for linguistic definition of intervals as well as mechanisms to adapt the mapping between intervals and linguistic terms. For example the meaning of the word “High” depends upon the context and the usage, e.g. temperature of a room in comparison with the temperature of a furnace. The reason why these techniques are useful in the context of meeting evaluation is because of their power to summarise, so that simple rules may be used to handle large intervals. Typically this makes the resultant software agents easier to develop, interpret and maintain.

According to a second aspect of the present invention, there is provided a software agent operable in a computer processing arrangement on behalf of at least one physical entity to evaluate event requests received over a communications network and to output a value for use by an event scheduler indicative of the overall degree of support by said at least one physical entity for a respective requested event, wherein the software agent is responsive, on receipt of an event request comprising information about the event, to apply fuzzy logic processing techniques to combine information about the requested event with information obtained from a plurality of information sources associated with said at least one physical entity to determine a value for each of a plurality of predetermined measures, said measures including a measure of the importance of the requested event to said at least one physical entity, the value for at least one of said measures being defined by a fuzzy set and the value for at least one of said measures being derived according to a fuzzy rule for the measure, and to apply a further rule set comprising at least one fuzzy rule to combine said values of said measures to derive and output a value indicative of the overall degree of support by said at least one physical entity for the requested event for input to an event scheduler.

Preferably, said software agent is also operable to receive an output by an event scheduler generated by the scheduler in respect of a requested event using a respective said value indicative of the overall degree of support by said at least one physical entity for the requested event and to adjust one of more fuzzy sets or fuzzy rules in respect of said at least one physical entity according to feedback received on behalf of said at least one physical entity in respect of said output by the event scheduler.

Preferred embodiments of the present invention will now be described, by way of example only, with reference to the accompanying drawings of which:

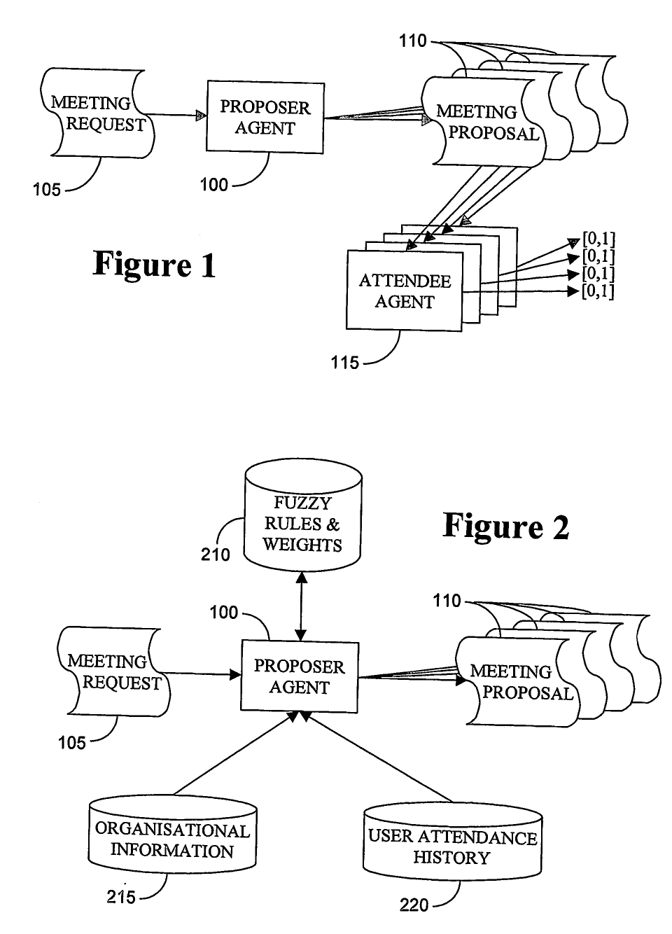

FIG. 1 shows an arrangement of software agents for use in generating responses to a meeting request according to preferred embodiments of the present invention;

FIG. 2 shows a proposer agent apparatus according to a preferred embodiment of the present invention;

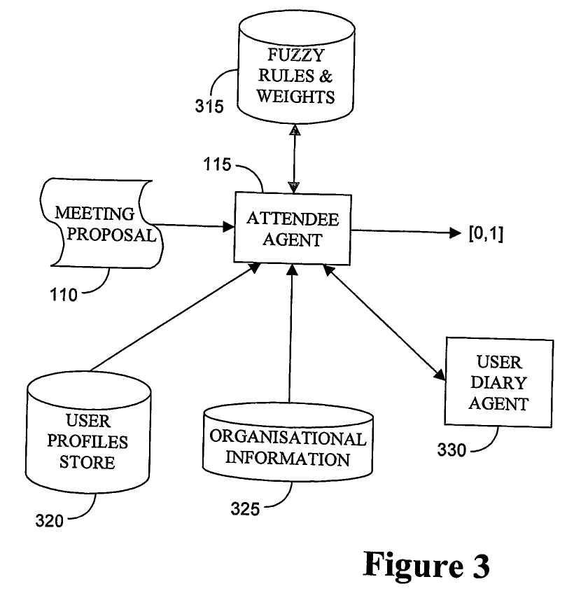

FIG. 3 is shows an attendee agent apparatus according to a preferred embodiment of the present invention;

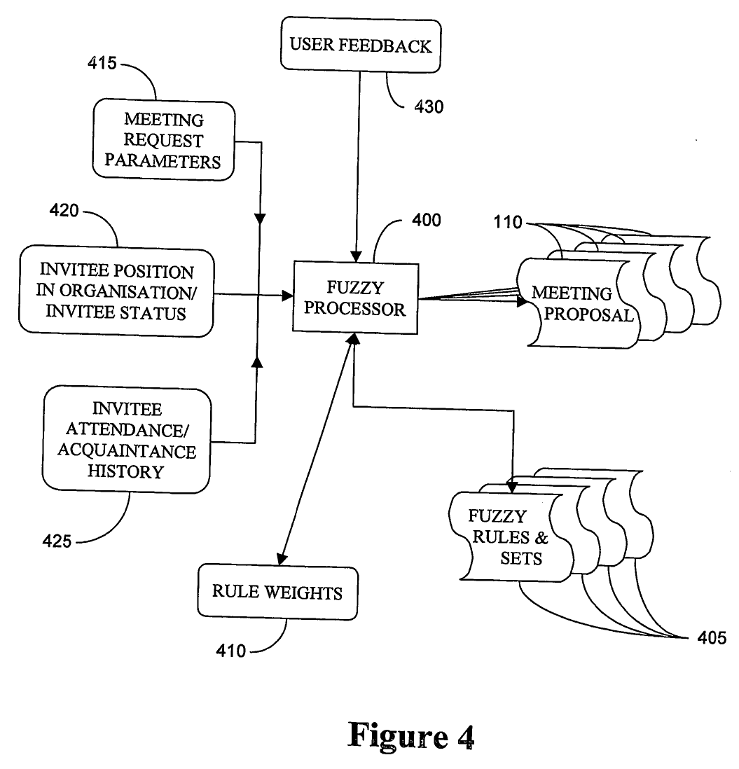

FIG. 4 is a diagram representing the data entities involved in the operation of a preferred proposer agent;

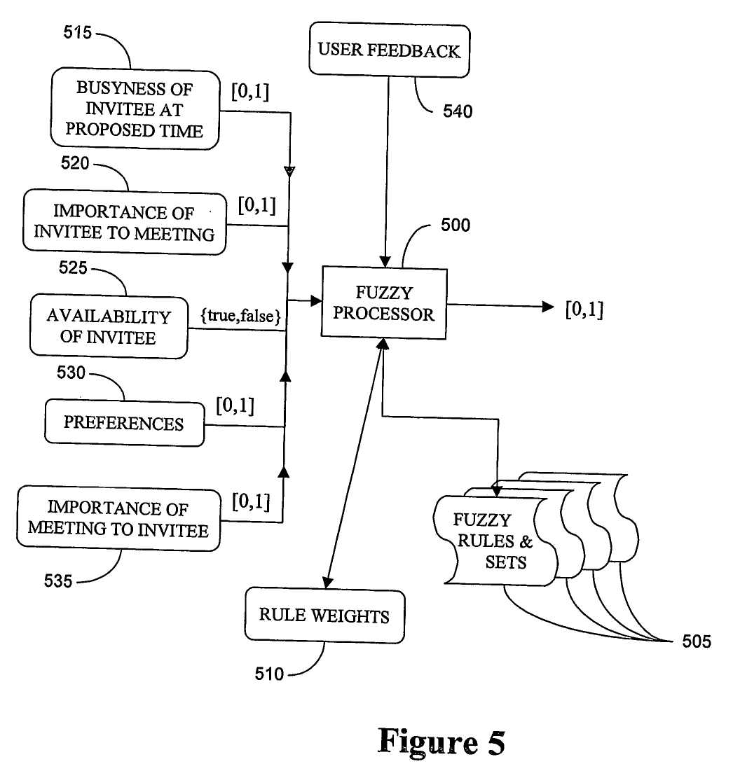

FIG. 5 is a diagram representing the data entities involved in the operation of a preferred attendee agent;

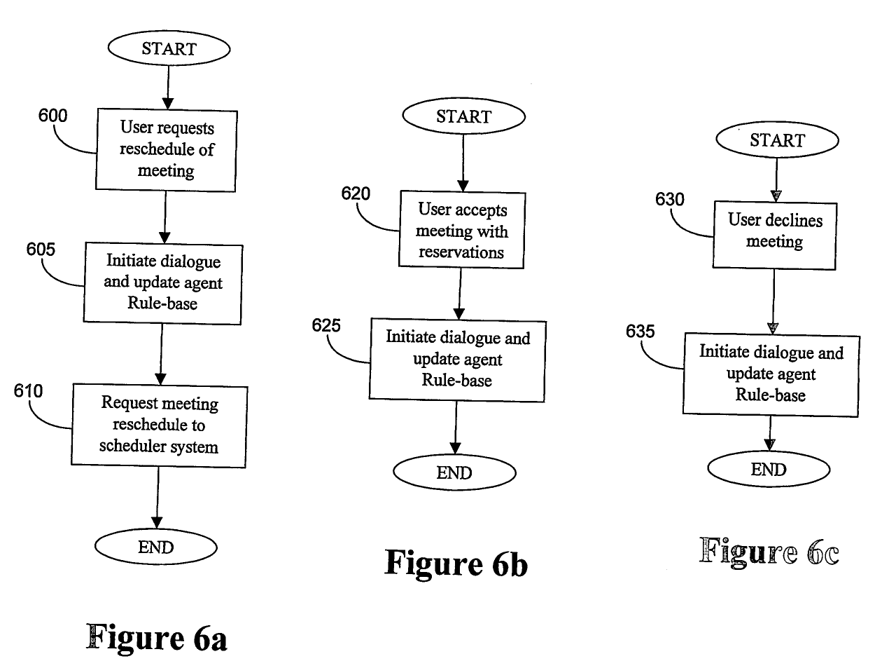

FIG. 6 shows three flow diagrams defining steps involved in three different types of attendee feedback in response to a scheduled meeting according to a preferred embodiment of the present invention;

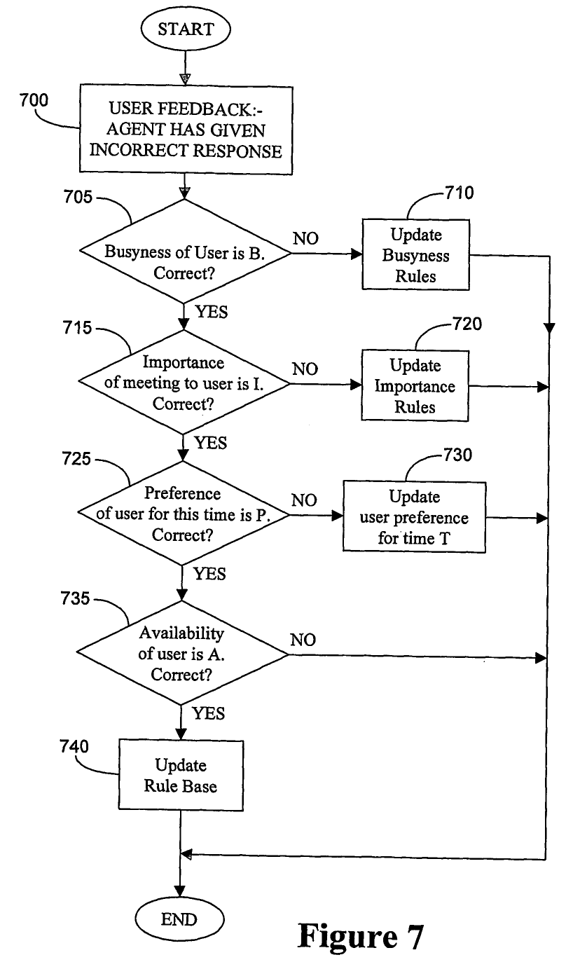

FIG. 7 is a flow diagram showing preferred steps in adapting fuzzy rules and/or rule weights in response to received attendee feedback;

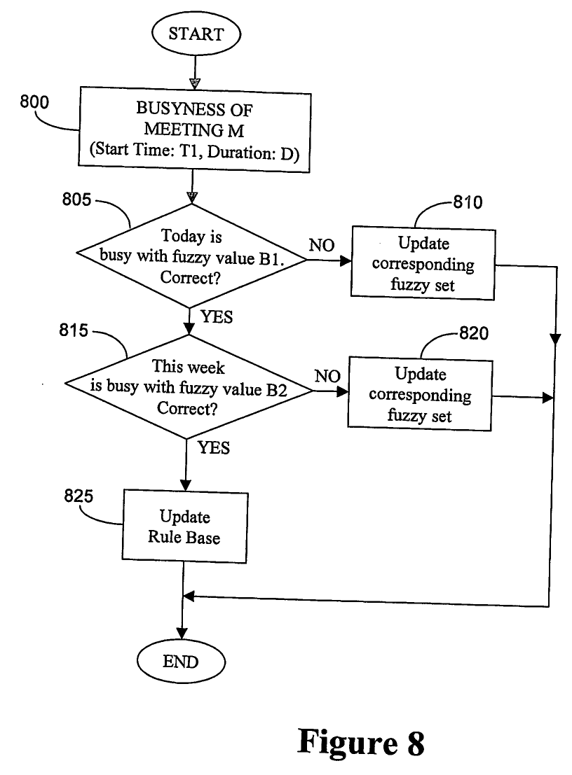

FIG. 8 is a flow diagram showing steps in updating a fuzzy set representative of a preferred measure of user busyness according to a preferred embodiment of the present invention; and

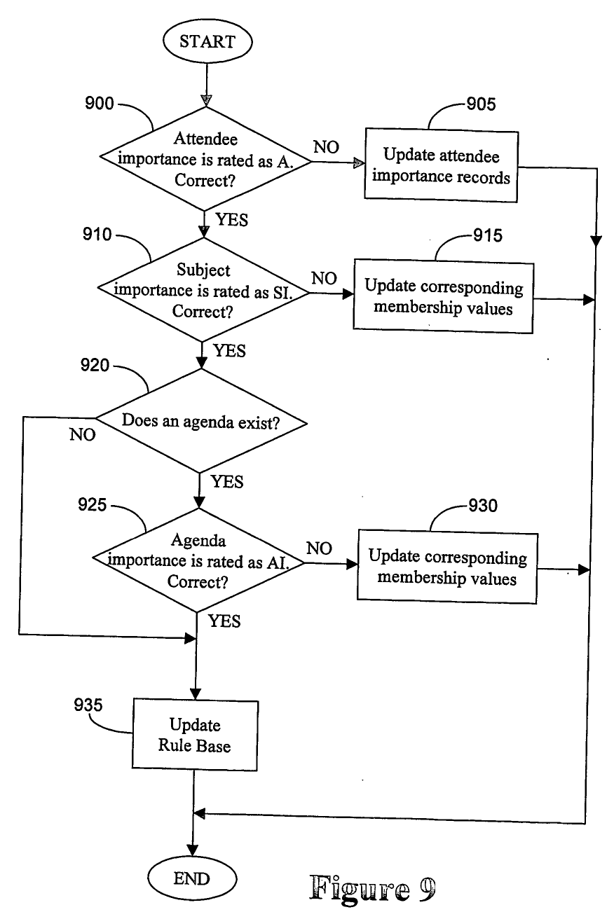

FIG. 9 is a flow diagram showing steps in updating a fuzzy set representative of preferred measures of importance according to a preferred embodiment of the present invention.

Preferred embodiments of the present invention will now be described in the specific context of their application to the generation and evaluation of meeting proposals, wherein the results of the evaluation are useable by known schedulers. However, it would be clear to a person of ordinary skill in the art that the present invention may be modified to generate and evaluate proposals for other types of event to be scheduled.

A simple arrangement of software agents for use in generating responses to a meeting request according to preferred embodiments of the present invention will now be described in outline with reference to FIG. 1. The preferred arrangement of FIG. 1 is intended to show that functionality for generating meeting proposals is preferably implemented separately from functionality for evaluating meeting proposals so generated. Any preferred external sources of information to be used by the software agents are omitted from FIG. 1.

Referring to FIG. 1, a proposer agent 100 is arranged to receive a meeting request 105 issued by a user or by another software agent. The meeting request 105 comprises parameters defining those characteristics of the meeting that the requester wishes to specify. In particular, the meeting request 105 preferably comprises an indication of a date, time and duration of the requested meeting, its proposed location and a list of invitees. Optionally, the meeting request 105 may also comprise an indication of the meeting topic and an agenda for the meeting. The proposer agent 100 is arranged to augment the received meeting request 105 with at least one further parameter in respect of each invitee or group of invitees and to generate a respective meeting proposal 110 for each invitee or group of invitees, as will be described below according to a preferred embodiment of the present invention. The proposer agent 100 is arranged to pass each generated meeting proposal 110 to an attendee agent 115 representing the respective invitee or group of invitees. Each attendee agent 115 is arranged to evaluate a received meeting proposal 110 and to generate a response to the proposal 110 on behalf of the respective invitee or group of invitees comprising a value in the range [0,1]. A preferred technique for evaluating a meeting proposal and for generating the response value will be described below according to a preferred embodiment of the present invention. The response values are intended for use by a meeting scheduler agent, not shown in FIG. 1, to enable an attendee list to be determined and communicated to the meeting requester and to the attendees themselves. A preferred technique by which attendees on the determined list may provide feedback, for example to request a reschedule of the requested meeting (105) or to request adjustment of particular meeting parameters, will also be described below according to a preferred embodiment of the present invention.

An apparatus for implementing preferred functionality of a proposer agent 100 will now be described with reference to FIG. 2 according to a preferred embodiment of the present invention.

Referring to FIG. 2, a proposer agent 100 is shown, arranged to receive meeting requests 105 and arranged with access to a store 210 of fuzzy rules and rule weights, a store 215 for containing organisational information in respect of at least some of the invitees specified in a received meeting request 105 and a store 220 for containing information, gathered by the proposer agent 100 for example, relating to the attendance history of meeting invitees. As will be described below, preferred embodiments of the proposer agent 100 are arranged to process information contained in the stores 210-220, using conventional fuzzy processing techniques, to generate one or more meeting proposals 110 corresponding to a received meeting request 105. The meeting proposal 110 may comprise a single proposal for sending to all attendee agents 115, or a plurality of meeting proposals 110 may be generated, each one individually tailored to an invitee or group of invitees and directed to their respective attendee agents 115.

A apparatus for implementing preferred functionality of an attendee agent 115 will now be described with reference to FIG. 3 according to a preferred embodiment of the present invention.

Referring to FIG. 3, an attendee agent 115 is shown, arranged to receive a meeting proposal 110 in respect of a particular invitee or group of invitees. The attendee agent 115 is arranged with access to a store 315 of fuzzy rules and rule weights, a store 320 for containing user profile information for at least some of the invitees specified in the meeting proposal 110, a store 325 for containing organisational information in respect of at least some of the invitees specified in the meeting proposal 110, the store 325 being preferably the same store 215 as used by the proposer agent 100 in FIG. 2, and to at least one diary agent 330 in respect of invitees specified in the meeting proposal 110. As will be described below, preferred embodiments of the attendee agent 115 are arranged to process information contained in the stores 315-325, and supplied by the diary agent 330, using conventional fuzzy processing techniques to generate a response to the received meeting proposal 110 comprising a value preferably in the range [0,1] for the respective invitee or group of invitees.

Operation of a proposer agent 100 according to a preferred embodiment of the present invention will now be described in more detail with reference to FIG. 4.

Referring to FIG. 4, and additionally to FIG. 2, the preferred proposer agent 100 comprises a fuzzy processor 400 arranged to implement a conventional fuzzy processing technique (see reference above), with reference to fuzzy rules and fuzzy sets 405 and corresponding rule weights 410, to combine data entities relating to and derived from meeting request parameters 415 in order to generate a meeting proposal 110. As mentioned above, the fuzzy processor 400 operates to augment the parameters 415 supplied in a meeting request 105 with at least one further parameter derived in respect of each invitee or group of invitees specified in the meeting parameters 415. Preferably the fuzzy processor 400 is arranged to use a different set of fuzzy rules 405 and corresponding rule weights 410 to generate each further parameter. The rule weights 410 may be personalised to each invitee to enable the performance of the proposer agent 100 to be personalised. Alternatively, a single set of rule weights 410 may be used, enabling the performance of the proposer agent 100 to be adjusted on a broader basis, e.g. with respect to an organisation as a whole.

The fuzzy processor 400 is arranged, in particular, to generate a further parameter, preferably in the form of a fuzzy set, indicative of the importance of each invitee to the meeting requested (105, 415). Preferably, the invitee importance parameter is derived by combining information 420 defining a respective invitee's position in a respective organisation, obtained from a store 215 containing organisational information, with information 425 relating to the invitee's attendance history at previous meetings, in particular meetings attended by one or more of the other invitees specified in the meeting request 105, obtained from a store 220 containing user attendance history data, and with the other parameters 415 in the meeting request 105 relating to meeting time and duration.

Preferably, a fuzzy rule 405 of the following type is used by the fuzzy processor 400 to derive a value indicative of an invitee's importance to the requested meeting (105, 415):

IF seniority_of_attendee is HIGH
AND regularity_of_attendee is HIGH
THEN importance_of_attendee is HIGH

Fuzzy sets are included within the fuzzy rule store 210 to define the meaning of HIGH in respect of each parameter of the rule. Other fuzzy sets may define for example “LOW” as required by different fuzzy rules 405. Preferably, fuzzy sets used in the conditional portion (“IF” portion) of a rule are personalised to each invitee or group of invitees so that the information 420 and 425 may be interpreted in a personalised manner by the fuzzy processor 400. A “high” attendance rate for one invitee may be quite different to that for another.

Having applied the fuzzy rule 405 in respect of each invitee or group of invitees specified in the meeting request parameters 415, the user importance parameters so determined are included, along with the other meeting request parameters 415, in a meeting proposal 110 output by the fuzzy processor 400. As mentioned above, this meeting proposal 110 may comprise a single proposal to be directed to the attendee agents 115 representing each of the specified invitees, or it may be personalised so some extent, for example to remove certain pieces of confidential information in respect of certain invitees, or simply to generate a more personalised meeting proposal 110 in respect of particular invitees.

The fuzzy processor 400 may also be arranged to receive user feedback 430 from invitees and to use the feedback 430 both in the generation of further meeting proposals 110 and in updating personalised rule weights 410 and fuzzy sets 405. A preferred process for handling user feedback 430 will be described below.

Operation of an attendee agent 115 according to a preferred embodiment of the present invention will now be described in more detail with reference to FIG. 5. Preferably, the attendee agent 115 operates on behalf of a single invitee or group of invitees to generate a response to a received meeting proposal 110 that is usable by a meeting scheduler.

Referring to FIG. 5, and additionally to FIG. 3, the preferred attendee agent 115 comprises a fuzzy processor 500 arranged to implement a conventional fuzzy processing technique (see reference above), with reference to fuzzy rules and fuzzy sets 505 and corresponding rule weights 510, to combine a predetermined set of data entities in order to generate and output a response to the received meeting proposal 110 in the form of a value in the range [0,1]. The set of data entities to be combined by the fuzzy processor 500 relate to and are derived from information contained in a received meeting proposal 110, preferably with reference to the information sources 320-330 shown in FIG. 3, according to weighted fuzzy rules stored in fuzzy rule store 315. The set of data entities comprises parameters taken directly from the received meeting proposal 110 itself and parameters separately derived, preferably by the fuzzy processor 500 in a pre-processing step, on receipt of the meeting proposal 110. As with the proposer agent 100 above, the fuzzy processor 500 is arranged to use a different fuzzy rule set 505 and corresponding rule weights 510 to generate each of the data entities that need to be separately derived and a further rule set 505 and rule weights 510 to generate the response to the meeting proposal 110. The rule weights 510 and any fuzzy sets corresponding to the fuzzy rules 505 are preferably personalised to the individual invitee or group of invitees represented by the attendee agent 115 to enable its performance to be personalised.

The following set of data entities is used by the fuzzy processor 500 to determine a response value for a meeting proposal 110, on behalf of the invitee or group of invitees, according to a preferred embodiment of the present invention:

Busyness of Invitee at the Proposed Time 515

this parameter has a value in the range [0,1] derived, preferably, by the fuzzy processor 500 using a corresponding fuzzy rule 505 and rule weight 510 to combine information obtained from a user diary agent 330 relating to the invitee's diary commitments at or around the proposed meeting time, and from historical information (e.g. obtained from the store 220 of user attendance history shown in FIG. 2) of responses to previous meeting proposals involving one or more of the invitee(s);

Importance of Invitee to the Meeting 520

this parameter has a value in the range [0,1] and was determined by the proposer agent 100 in respect of the invitee or group of invitees and supplied in the received meeting proposal 110;

Availability 525

this parameter comprises a fuzzy set {true, false} indicating the degree of support for whether the invitee is available (true) and not available (false). Preferably, this parameter is derived by the fuzzy processor 500 using a corresponding fuzzy rule 505 and rule weight 510 to combine information drawn from one or more sources identifying reasons, other than purely temporal, that may affect the invitee's availability, for example being located too far away to be able to travel conveniently to the proposed meeting location;

Preferences 530

this parameter has a value in the range [0,1] derived, preferably, by the fuzzy processor 500 using a corresponding fuzzy rule 505 and rule weight 510 to combine information derived, in particular, with access to a user profile store 320 relating not only to the invitee's interests, as compared with the topic or agenda of the proposed meeting 110, but also to preferences for particular times of day, days of the week, locations, etc. as compared with the corresponding parameters in the meeting proposal 110 (insofar as they are specified);

Importance of Meeting to the Invitee 535

this parameter has a value in the range [0,1] derived, preferably, by the fuzzy processor 500 using a corresponding fuzzy rule 505 and rule weight 510 to combine, for example, information about the invitee's position in the organisation, obtained from the store 325 of organisational information, with information obtained from the user profile store 320 regarding the invitee's interests, and information recording the invitee's regular meeting partners, stored for example in the user attendance history store 220 accessible also to the proposer agent 100. A fuzzy rule 505 of the type

IF seniority_of_any_invitee is HIGH
AND number_of_regular_attendees is HIGH
AND match_of_agenda_to_user_profile is HIGH
THEN imporance_of_meeting is HIGH

may be used to determine a value in the range [0,1] for this parameter. As above, fuzzy sets 505, personalised to the invitee or group of invitees represented by the attendee agent 115, are stored to define the meaning of HIGH in respect of each parameter tested by the rule 505. If the result of applying this rule 505 is a fuzzy set HIGH, then this may be translated into a value for output, in the range [0,1], chosen to represent “HIGH”. This value may be adjusted in response to feedback 540 by the represented invitee or group of invitees to enable the performance of the attendee agent 115 to be fine-tuned.

A preferred process by which user feedback 540 may be used to adjust rule weights 510 and fuzzy sets (505), and hence the operation of the fuzzy processor 500, will be described below.

Once values or fuzzy sets have been obtained or derived to represent each of the data entities 515-535 for the invitee, the fuzzy processor 500 applies one or more fuzzy rules 505 and corresponding rule weights 510 to combine the values for each of the data entities 515-535 in order to generate the response value to the meeting proposal 110 on behalf of the represented invitee(s). Preferably, a fuzzy rule 505 of the type

IF busyness_of_user at time t IS low
AND importance_to_user IS high
AND availability_of_user at time t IS true
AND importance_of_user IS high
AND time preference of user at time t IS high
THEN accept_proposal_support IS HIGH

is used to combine the values 515-535, where the time t is the proposed time of the meeting in the received meeting proposal 110. As above, the fuzzy set “HIGH” is converted into a value in the range [0,1] for output, a value that may be adjusted through feedback 540 by the represented invitee(s) to fine-tune the performance of the attendee agent 115. The output value is usable according to a number of different known scheduling techniques when attempting to determine the optimal list of attendees for a requested meeting (105) and such scheduling techniques will not be described in the present patent specification.

A process will now be described, according to a preferred embodiment of the present invention, by which invitees may provide feedback 430, 540 to the proposer agent 100 and, more particularly, to their attendee agent 115, respectively, to trigger an adjustment to the response of the agents 100, 115 to a received meeting request 105. Preferably, an invitee or group of invitees provides appropriate feedback 430, 540 once the effect of the respective agent's response has been determined in respect of that invitee or group of invitees, i.e. once the invitee becomes aware of the output of the scheduler and is either included or not included in a determined list of attendees for the requested meeting (105), scheduled to take place at a particular time and place.

Preferably, invitee feedback 430, 540 may comprise one of the following responses:

1) invitee asks for reschedule of meeting

2) invitee accepts schedule but “with reservations”

3) invitee declines invitation

4) acceptance/no feedback.

In case 4) it is assumed that the attendee agent 115 has given the correct response and no further action is required. In cases 1)-3) the attendee agent 115 may be arranged to initiate a dialogue with the invitee to discover which of its assumptions need updating, i.e. which rule weights 510 or fuzzy sets (505) need to be adjusted. In case 1) the proposer agent 100 may also request a reschedule from the scheduler.

Preferably, an invitee responds either by a) explicitly, answering a message from the attendee agent 115 describing the parameters of a meeting it has “agreed to” (generated a high value) or b) implicitly, by altering or commenting on an entry made in the invitee's diary (330). The different invitee responses will now be described with reference to FIG. 6.

Referring to FIG. 6a, corresponding to invitee response 1) above, the invitee firstly, at STEP 600, requests a reschedule of the meeting. At STEP 605 the attendee agent 115 responds to the request by initiating a dialogue with the invitee to enable its rule base 505, 510 to be adjusted. Having completed the adjustment, at STEP 610 the attendee agent 115, or the proposer agent 100, requests a rescheduling of the meeting by the scheduler system.

Referring to FIG. 6b, corresponding to invitee response 2) above, the invitee firstly, at STEP 620, accepts the scheduled meeting but with reservations. At STEP 625, the attendee agent 115 initiates a dialogue with the invitee to enable its rule base 505, 510 to be adjusted in accordance with the invitee's reservations.

Referring to FIG. 6c, corresponding to invitee response 3) above, the invitee firstly, at STEP 630, declines the invitation. At STEP 635, the attendee agent 115 initiates a dialogue with the invitee to enable its rule base 505, 510 to be adjusted, where necessary, in accordance with the invitee's reasons for rejection.

In each of the three types of response shown in FIG. 6, a dialogue and adjustment step 605, 625, 635 is carried out by the attendee agent 115 on behalf of the invitee. A preferred process for carrying out these dialogue and adjustment steps 605, 625, 635 will now be described in more detail with reference to FIG. 7.

Referring to FIG. 7, at STEP 700 the attendee agent receives an invitee response 600, 620, 630 indicating that, to some degree, the attendee agent 115 has generated an incorrect response to a received meeting proposal 110. At STEP 705, the attendee agent 115 asks the invitee whether the value for the parameter Busyness of invitee at proposed time 515 was correct. If not, then at STEP 710 a process is executed by the attendee agent 115 to update the fuzzy rules 505, 510 relating to this parameter 515, as will be described below with reference to FIG. 8. If the parameter 515 was correct, then at STEP 715, the attendee agent 115 asks the invitee whether the values for the parameter Importance of meeting to the invitee 535 was correct. If not, then at STEP 720 a process is executed by the attendee agent 115 to update the fuzzy rules 505 and weights 510 relating to this parameter 535, as will be described below with reference to FIG. 9. If the parameter 535 was correct, then at STEP 725, the attendee agent 115 asks the invitee whether the determined value for the invitee's Preferences parameter 530 for the proposed meeting time was correct. If not, then at STEP 730, the attendee agent 115 may be arranged, for example, to update the invitee's personalised fuzzy sets (505). For example, if the invitee indicates that the preference parameter value 530 was too high, then the membership value in the fuzzy set representing “HIGH” may be decreased; if too low, then the membership value may be increased. Alternatively, fuzzy representations of preferences stored in the user profile store 320 may be updated insofar as they relate to the proposed meeting time, e.g. a fuzzy preference for Tuesdays may need to be adjusted upwards or downwards, as appropriate.

If the parameter 530 was correct at STEP 725, then at STEP 735, the attendee agent 115 asks the invitee whether the fuzzy membership values for the parameter Availability 525 were correct, If so, then at STEP 740, the fuzzy rules 505 and rule weights 510 may be adjusted overall to reinforce the likelihood of the attendee agent 115 generating a similar response to a similar subsequent meeting proposal 110. In particular, updates may be carried out by the fuzzy processor 500 by applying a rule of the type

IF X is LOW
AND y is HIGH
AND z is MEDIUM
THEN proposal_support is HIGH with weight W

where x, y and z are fuzzy indications by the invitee of the correctness of the parameter values in questions 705, 715 and 725 above, respectively. The fuzzy processor 500 is arranged to make overall adjustments as follows:
i) locate rules 505 which fire with highest fuzzy value V, decreasing the corresponding rule weights 510; and
ii) locate rules 505 which fire with lower fuzzy values than V, increasing their rule weights 510.

A preferred process for carrying out updating STEP 710 in relation to the busyness parameter 515 will now be described with reference to FIG. 8.

Referring to FIG. 8, at STEP 800 the attendee agent 115 presents to the invitee the value of the busyness parameter 515 and the meeting parameters of time and duration. At STEP 805, the agent 115 asks the invitee if the fuzzy value B1 representing the invitee's busyness on that day is correct. If the invitee indicates not, then at STEP 810, the fuzzy processor 500 is arranged to make an appropriate update to the corresponding fuzzy set. For example, if a busy_day fuzzy set is indicated by a fuzzy membership value of greater than 1, then if the derived parameter value for busyness 515 is too high, then the membership value for the busy_day fuzzy set may be adjusted downwards. Conversely, if the derived value 515 is too low, then the membership value for the busy_day fuzzy set may be adjusted upwards.

If at STEP 805, the busyness parameter 515 was correct, then at STEP 815 the agent 115 asks if the fuzzy value B2 representing the invitee's busyness on that week is correct. if not, then at STEP 820, a similar updating step is carried out to that in STEP 810 above. If at STEP 815 the parameter value was also correct, then at STEP 825, a similar “reinforcing” update is made to the corresponding rules 505 and weights 510 as in STEP 740 of FIG. 7 above.

A preferred process for carrying out updating STEP 720 will now be described with reference to FIG. 9.

Referring to FIG. 9, at STEP 900, the attendee agent 115 asks if the invitee importance parameter value was correct. If not, then at STEP 905, a fuzzy set corresponding to the invitee's importance in the organisation may be updated, e.g. if the agent 115 predicted a value that was too low, then the fuzzy membership value associated with the invitee may be increased, or decreased if the predicted value was too high.

If, at STEP 900 the value was correct, then at STEP 910 the agent 100 asks if the rating of meeting subject importance was correct. If not, then at STEP 915 a corresponding update to fuzzy membership values is made, otherwise, at STEP 920, the agent 115 determines whether a meeting agenda was included in the original meeting request 105. If so, then at STEP 925 the attendee agent 115 asks the invitee if the importance value for the agenda was determined to be correct. If not, then at STEP 930 a corresponding update to fuzzy membership values is made, otherwise, at STEP 935, a similar “reinforcing” update is made to the corresponding rules 505 and weights 510 as in STEP 740 of FIG. 7 above.

The processes for updating fuzzy rules and fuzzy sets in FIGS. 7 to 9 above may be extended to other meeting attributes, besides those specifically described. The general approach is to present the agent's (115) prediction of a particular parameter to the invitee. If this prediction does not match with the invitee's assessment then the fuzzy rules for that parameter are updated either by a) adjusting the membership values of the fuzzy sets (505), or b) adjusting the weights 510 corresponding to the rules 505. In the case where the invitee concurs with all the agent's assessments, but the final response to a meeting proposal 110 by the agent 115 is not correct, then the overall rule base 505, 510 is updated accordingly.

There are a number of variations to preferred embodiments of the present invention described above that would be apparent to a person of ordinary skill in the art. For example, while the roles of proposer agent 100 and attendee agent 115 have been described as operating separately, then may of course be combined into a single software agent implementation while still treating the evaluation of a proposed meeting slot separately from the scheduling of the meeting. It would also be apparent that other combinations of parameters may be used to derive measures relevant to the evaluation of a meeting proposal 110 which continuing to employ the advantageous techniques of fuzzy processing and fuzzy representation used in preferred embodiments of the present invention.

1. An event scheduling apparatus for use in scheduling events on behalf of a plurality of participating physical entities, the apparatus comprising evaluating means and scheduling means, the evaluating means being arranged to evaluate a received event request comprising information about the event and to generate an input to the scheduling means with respect to one or more physical entities identified in the received event request, the evaluating means comprising determining means operable on behalf of at least one physical entity identified in the received event request, to:
a) determine a value for each of a plurality of predetermined measures, said measures including a measure of the importance of the requested event to said at least one physical entity, the value for each said measure being derived according to a rule set for the measure by combining information about the event with data obtained from at least one information source associated with said at least one physical entity; and
b) combine said determined values, according to a further rule set, to derive a value indicative of the overall degree of support by said at least one physical entity for the requested event, and to output said derived value for input to the scheduling means,
wherein at least one of said values is defined by means of a fuzzy set, at least one of said rule sets comprise at least one fuzzy rule and wherein said determining means comprise at least one fuzzy logic processor.

2. An event scheduling apparatus as in claim 1, wherein said determining means are implemented, in use, as a plurality of participant software agents, each participant software agent being operable on behalf of at least one physical entity identified in the received event request.

3. An event scheduling apparatus as in claim 2, wherein the evaluating means further comprise a proposer software agent operable to receive an event request and, for one or more physical entities identified therein, to:
i) determine a value for a measure of the importance of the identified physical entity to the requested event, each said value being derived according to a rule set for said measure by combining information about the event with data obtained from at least one information source associated with the identified physical entity; and
ii) generate an event proposal comprising the importance value from i) together with information about the event, for sending to the respective participant software agent for the identified physical entity.

4. An event scheduling apparatus as in claim 1, wherein said rule sets are personalised to respective physical entities.

5. An event scheduling apparatus as in claim 1, wherein the evaluating means further comprise adjusting means arranged to receive feedback by, or on behalf of, a physical entity in relation to an output by the scheduling means corresponding to a received event request in which said physical entity is identified, and to make adjustments to fuzzy sets and/or fuzzy rules in accordance with said received feedback.

6. An event scheduling apparatus as in claim 1, wherein the evaluating means and the scheduling means are implemented in a distributed manner.

7. (canceled)

8. A software agent operable in a computer processing arrangement on behalf of at least one physical entity to evaluate event requests received over a communications network and to output a value for use by an event scheduler indicative of the overall degree of support by said at least one physical entity for a respective requested event, wherein the software agent is responsive, on receipt of an event request comprising information about the event, to apply fuzzy logic processing techniques to combine information about the requested event with information obtained from a plurality of information sources associated with said at least one physical entity to determine a value for each of a plurality of predetermined measures, said measures including a measure of the importance of the requested event to said at least one physical entity, the value for at least one of said measures being defined by a fuzzy set and the value for at least one of said measures being derived according to a fuzzy rule for the measure, and to apply a further rule set comprising at least one fuzzy rule to combine said values of said measures to derive and output a value indicative of the overall degree of support by said at least one physical entity for the requested event for input to an event scheduler.

9. A software agent as in claim 8, operable to receive an output by an event scheduler generated by the scheduler in respect of a requested event using a respective said value indicative of the overall degree of support by said at least one physical entity for the requested event and to adjust one of more fuzzy sets or fuzzy rules in respect of said at least one physical entity according to feedback received on behalf of said at least one physical entity in respect of said output by the event scheduler.
